(19) United States
(12) Patent Application Publication
(10) Pub. No.: US 2014/0367934 A1
(43) Pub. Date: Dec. 18, 2014

(54) WHEELBARROW WITH IMPROVED CAPACITY AND EASE OF USE

(71) Applicant: BEARZALL, LLC, Murray, UT (US)

(72) Inventor: Loren Ludlow, Saint George, UT (US)

(73) Assignee: BEARZALL, LLC, Murray, UT (US)

(21) Appl. No.: 14/304,882

(22) Filed: Jun. 14, 2014

Related U.S. Application Data
(60) Provisional application No. 61/835,315, filed on Jun. 14, 2013.

(51) Int. Cl. B62B 1/18

(52) U.S. Cl. CPC B62B 1/18
USPC 280/47.26; 280/47.31

(57) ABSTRACT

A wheelbarrow is provided. The wheelbarrow may include a frame, a handle at the rear of the frame for allowing a user to lift the frame and move the wheelbarrow, a bucket for carrying a load, the bucket having a lower surface, a front surface, and a concave recess disposed between the lower surface and the front surface and extending upwardly into the bucket, and a wheel disposed in the recess such that a top of the wheel is located above the bottom surface of the bucket and a back of the wheel is located behind the front surface of the bucket.

### PRIORITY

The present application claims the benefit of U.S. Provisional Application Ser. No. 61/835,315, filed Jun. 14, 2013, which is herein incorporated by reference in its entirety.

### THE FIELD OF THE INVENTION

The present invention relates to wheelbarrows. More specifically, the present invention relates to a wheelbarrow which provides high capacity while reducing the effort to lift and move the wheelbarrow as well as providing improved stability and resistance to tipping over.

### BACKGROUND

Wheelbarrows are commonly used. Many persons such as homeowners, landscapers, construction workers, etc. use wheelbarrows for moving dirt, rocks, concrete, and many other materials. Wheelbarrows are often used while performing tasks such as constructing a building, installing or maintaining landscaping, gardening, general yard work, etc. Wheelbarrows increase the ease, efficiency, and speed of lifting and moving a load. While wheelbarrows increase the speed and ease of moving materials, they still present some difficulty during use as the user is typically moving a significant weight of material. Many individuals encounter difficulty in maintaining control over a wheelbarrow while moving a heavy load.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIGS. 1A and 1B show side views of a wheelbarrow of the present invention;

FIG. 2 shows a front view of the wheelbarrow of FIG. 1;

FIG. 3 shows another side view of the wheelbarrow of FIG. 1;

FIG. 4 shows a side view of the bucket of the wheelbarrow of FIG. 1;

FIG. 5 shows a front view of the bucket of the wheelbarrow of FIG. 1;

FIG. 6 shows a front view of the frame of the wheelbarrow of FIG. 1;

FIG. 7 shows a front view of the wheelbarrow of FIG. 1; and

FIG. 8 shows a front view of the wheelbarrow of FIG. 1.

Corresponding reference characters indicate corresponding components throughout the several views of the drawings. Skilled artisans will appreciate that elements in the figures are illustrated for simplicity and clarity. While the drawings have been drawn to scale to illustrate aspects of the wheelbarrow, the dimensions of some of the elements in the figures may be exaggerated or changed relative to other elements in some examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

According to one example of the invention, a wheelbarrow is provided with a bucket which has a lower-front portion which is recessed into the space typically occupied by the wheelbarrow bucket, allowing placement of one or more wheels beneath the bucket while permitting the bucket to extend down to the wheel axle or even below the wheel axle. The lower front portion may be recessed such that the recessed portion extends above the bottom surface of the wheelbarrow bucket and behind the front surface of the bucket. The wheelbarrow wheels are placed beneath the bucket without raising the bucket above the wheels and extend upwardly above the bottom surface of the bucket and behind the front surface of the bucket. The wheelbarrow wheels may be located such that the wheel axle is located at or near the bottom of the bucket or even above the bottom of the bucket. The wheel axle may simultaneously be located at or behind the front edge of the bucket. Placement of the wheel axle at or behind the front of the bucket reduces the lifting effort required to lift a heavy load in the wheelbarrow. Simultaneously, the wheelbarrow allows the bucket to be close to the ground, maintaining a low center of gravity. This results in a wheelbarrow which is more stable and which is more easily controlled during use. Providing a bucket which extends downwardly adjacent or below the wheel axle allows the wheelbarrow bucket to have a high capacity without requiring the bucket to be overly wide or tall. The bucket is placed low to the ground while filling and using the wheelbarrow.

According to another example, a wheelbarrow may be provided which allows for use of one, two, or three wheels which are located within a recess occupying the traditional trapezoidal volume of the wheelbarrow bucket. A user may choose to operate the wheelbarrow with a single wheel, two wheels, or three wheels according to the encountered load and terrain, and may do so without requiring movement of the wheel to a different location on the wheelbarrow. Use of a single wheel may allow the wheelbarrow to be maneuvered over uneven terrain more easily. Use of two or three wheels may allow more weight to be carried without undue pressure on the terrain and may provide for increased lateral stability. In each configuration, the wheel(s) may be located partially behind the front of the bucket and may have the axle located at or behind the front face of the bucket. Placing part of the wheels in a recess which extends into the trapezoidal volume of the wheelbarrow bucket allows the wheels to be placed in a rearward position with a bucket which is placed low without placing the wheels to the side of the bucket or compromising bucket volume.

These and other aspects of the present invention are realized in a wheelbarrow as shown and described in the following figures and related description.

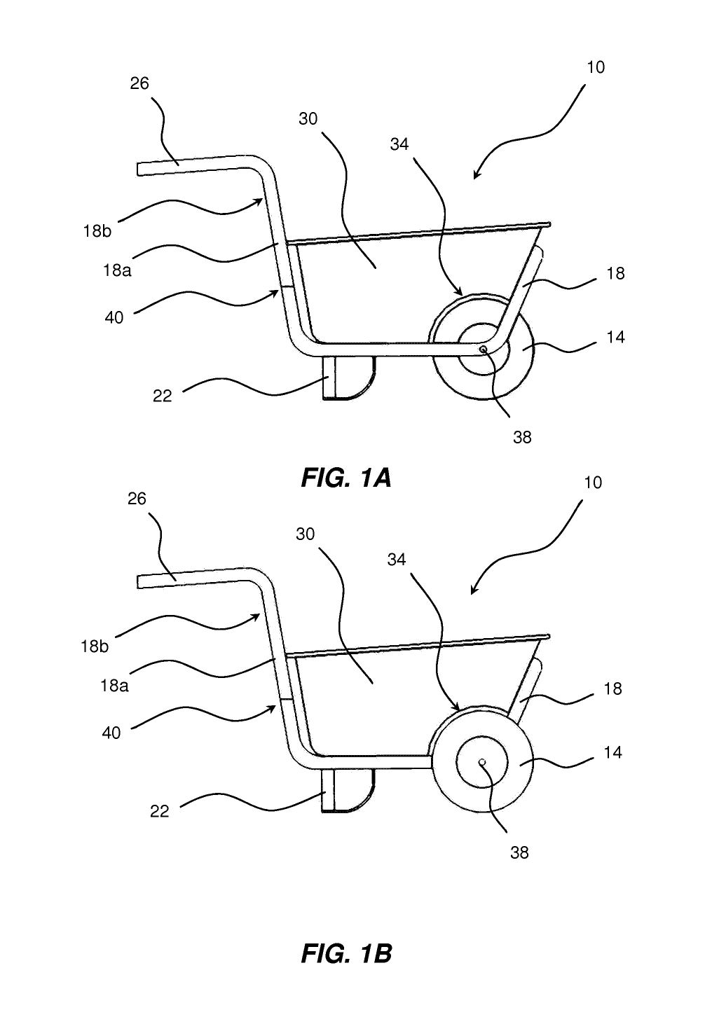

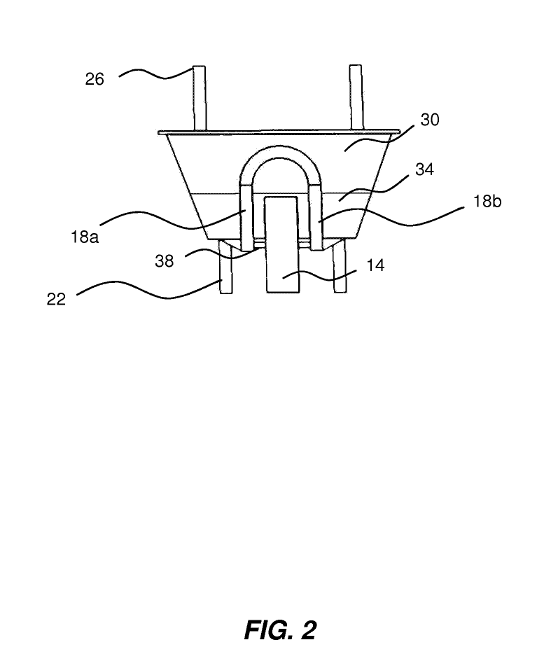

Turning now to FIGS. 1A. 1B, and 2, side and front views of a wheelbarrow 10 are shown. The wheelbarrow may include one or more wheels 14, a frame 18, legs 22, handles 26, and a bucket 30. The frame 18 typically includes two side pieces 18a, 18b disposed on alternate sides of the center of the wheelbarrow 10. The frame side pieces 18a, 18b may be closer together at the front of the wheelbarrow 10 and farther apart at the rear so as to provide integral handles 26. The frame side pieces 18a, 18b may be connected in front of the wheelbarrow 10 with an arch or cross bar 34 or similar structure in order to strengthen the frame 18. The frame 18 may include one or more cross bars extending between the frame side pieces 18a, 18b beneath the bucket 30, behind the bucket, or adjacent the handles 26 to strengthen the frame. The bucket 30 may be supported on top of the frame 18 and legs 22 may be attached to the frame to place the handles at a usable height and to support the wheelbarrow in a desired resting position.

The wheelbarrow bucket 30 includes a recess 34 formed in the front of the bucket adjacent the wheel 14. Some or all of the recess 34 may be formed with a generally rounded shape when viewed from the side so that the wheel 14 nests within the recess 34. Typically, a wheelbarrow bucket is formed with a convex geometry when viewed from the side. Traditional wheelbarrow buckets are trapezoidal in shape when viewed from the side and include a bottom, front, top, and back sides. In contrast, the recess 34 of the present wheelbarrow bucket 30 forms a concave section at the lower front portion of the wheelbarrow bucket 30. The recess 34 is typically disposed adjacent a location where the bottom of the wheelbarrow bucket 30 would meet with the front of the wheelbarrow bucket. The wheelbarrow bucket 30 defines a closed surface around the recess 34 and the recess does not form an opening through the material forming the bucket, but forms an indentation in the bucket.

The recess 34 allows the wheel 14 to be placed upwardly and rearwardly into the space bounded by the trapezoidal outline of a conventional bucket. This allows the wheel 14 to be both higher up relative to the bottom of the bucket 30 and farther back relative to the front of the bucket without being placed to the side of the bucket. Without the recess 34, the wheel 14 (or wheels 14) would need to be located either beneath the bucket 30, forwards in front of the bucket, or to the side of the bucket.

Positioning the wheel beneath a conventional bucket which does not include a recess 34 requires that the entire bucket is raised above the wheel. This results in a high center of gravity of a load which is placed in the bucket and makes the wheelbarrow unstable. Additionally, raising the entire bucket increases the height to which a person must lift material which is placed in the bucket. Positioning the wheel in front of a conventional bucket increases the force required to lift a wheelbarrow bucket which is full of material off of the ground for transport and makes the wheelbarrow longer and more difficult to maneuver. Placing wheels to the side of the wheelbarrow bucket makes the wheelbarrow wider and more difficult to fit through narrow openings, and also makes it more difficult to load the wheelbarrow from the side.

The wheelbarrow frame 18 may be formed to provide increased strength and to position the wheel 14 within the recess 34. The frame 18 may extend along the bottom surface of the wheelbarrow bucket 30 and may be attached to the bottom of the bucket 30. The frame 18 may be bent upwardly so that the frame also extends along the front surface of the bucket 30. The frame 18 may be attached to the front of the bucket 30, allowing the frame and the bucket to brace and strengthen each other. The recess 34 may extend upwardly into the volume typically occupied by a bucket to provide a recessed location to receive the wheel(s) 14 within the space usually occupied by the bucket 30. The recess thus extends upwardly from the bottom surface of the bucket and backwards from the front surface of the bucket. The section of the frame 18 corresponding to the recess 34 (i.e. extending around the recess 34) may extend away from the wheelbarrow bucket 30 in the area of the recess 34 and may provide a mounting location for an axle 38 to support the wheel 14.

In the area of the recess 34, the frame 18 may extend forwards from the bottom of the bucket 30 in alignment with the bottom of the bucket and may include a bend or curve to then place the front of the frame 18 in alignment with the front face of the bucket. In this manner, the frame 18 may have a shape which matches a wheelbarrow bucket which does not have a recess. The front part of the frame 18 may include a generally flat lower section, a bend, and a generally flat front portion. The wheelbarrow bucket 30 may rest in the frame 18 so that the bottom of the wheelbarrow bucket is attached to the generally flat lower portion of the frame and the front of the frame is attached to the generally flat front portion of the frame. The portion of the bucket forming the recess 34 thus may not be attached to the frame 18 in all examples; instead extending upwardly away from the lower front portion of the frame.

The axle 38 may be attached to the frame 18. In one example, the axle 38 may pass through the frame tube or may be attached to the frame tube with a bushing, bearing, bracket, or mount. The axle 38 may be positioned adjacent the plane of the lower surface of the bucket and may be positioned adjacent the plane of the front surface of the wheelbarrow bucket 30. Rather than being positioned well in front of or beneath the wheelbarrow bucket to thereby position the wheel 14 in front of or beneath the bucket, the axle 38 may be located adjacent or in the plane of the bottom face of the wheelbarrow bucket 30 and be located adjacent or in the plane of the front face of the wheelbarrow bucket. This axle location positions the wheel 14 in the recess 34 such that the wheel extends above the generally flat bottom surface of the bucket 30 and also extends rearwardly behind the front surface face of the bucket.

The rear portion of the frame 18 may extend upwardly from the bottom portion of the frame and may extend upwardly adjacent the back of the bucket 30. The rear portion of the frame 18 may extend above the bucket 30 to a desired height and extend backwards forming handles 26. The handles 26 may be placed at a comfortable operating height for a person using the wheelbarrow. If desired, the frame 18 may include a joint 40 which allows the handles 26 and upper/rear portion of the frame to separate from the rest of the frame. This may be particularly useful to reduce the size of the wheelbarrow 10 for shipping. A joint 40 in the frame 18 may allow the wheelbarrow to be shipped with the main portion of the frame attached to the bucket 30 and with the handles 26/rear portion of the frame, wheels 14, and legs 22 placed in the wheelbarrow bucket 30. This results in a shipping size which is not significantly larger than the bucket 30 alone. Legs 22 may be attached as needed to the bottom of the wheelbarrow frame 18. The legs 22 may be sized to place the bottom of the frame 18 approximately level to the ground, and may be about half the diameter of the wheel 14.

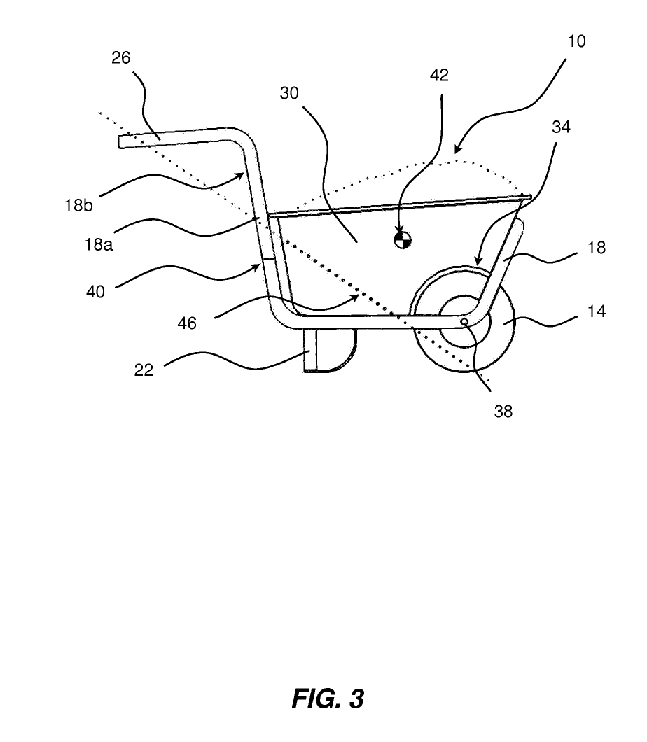

A significant advantage provided by the wheelbarrow 10 is that the center of gravity 42 of the loaded wheelbarrow is relatively low to the ground and is easily managed by a user as shown in FIG. 3. If an imaginary line 46 is drawn between the base of the wheel 14 and the handles 26, it can be seen that a significant portion of the wheelbarrow bucket 30 is disposed beneath the imaginary line and that the center of gravity 42 of a bucket 30 which is filled with a heavy material such as dirt is a relatively small distance above the line 46. This makes the wheelbarrow 10 stable and easy to control, since the distance between the center of gravity 42 and the imaginary line 46 represents the magnitude of the tipping moment exerted by a load carried in the wheelbarrow if held out of position. It can be seen how a partially loaded wheelbarrow bucket may result in a center of gravity which may be beneath the line 46.

The lateral stability of a wheelbarrow is related to the distance of the center of gravity above/below such an imaginary line 46 as the wheelbarrow 10, if rotating sideways, would rotate more or less about the line 46 and the distance of the center of gravity 42 above or below the line would indicate the tendency of the wheelbarrow to tip over. If the center of gravity 42 were below the imaginary line 46, the wheelbarrow would be self-correcting and would resist tipping over laterally. If the center of gravity were high above the line 46, the wheelbarrow would readily tip over if displace from a level position. Where the center of gravity 42 is near the line 46 but above the line 46 as with the wheelbarrow 10, the wheelbarrow is easily controlled and prevented from tipping over laterally but does not resist being intentionally tipped over laterally to empty the wheelbarrow if desired. This provides a good balance of ease of use and control to a person using the wheelbarrow 10. The wheelbarrow 10 may be loaded heavily during use without adversely affecting the stability of the wheelbarrow. This allows a user to maximize the weight carried in each wheelbarrow load in order to reduce the number of loads necessary and complete a job faster.

Additionally, the wheel 14 is placed such that the wheel axle 38 (and location where the wheel touches the ground) are close to the center of gravity 42 horizontally. The wheelbarrow 10 places the wheel axle 38 at a distance from the load center of gravity 42 which is less than half of the distance between the axle and load on prior art wheelbarrows commonly used today. The lifting leverage of the wheelbarrow 10 (the distance between the handles 26 and axle 38 divided by the distance between the load center of gravity 42 and the axle 38) is approximately 3.5:1 where the lifting leverage of commonly used wheelbarrows is approximately 2:1. The wheelbarrow 10 thus requires approximately half of the force to lift a load compared to a traditional wheelbarrow.

The design and location of the wheelbarrow bucket 30 is advantageous as a large capacity bucket may be provided while maintaining both the bottom and the top of the bucket relatively close to the ground. This bucket configuration makes it easier to load the wheelbarrow. If a person is loading dirt or the like into a wheelbarrow with a shovel, the dirt typically lands in the wheelbarrow bucket with significant sideways momentum and may often tip the wheelbarrow over. A wheelbarrow is particularly susceptible to being topped over if it is not on flat and level ground. The wheelbarrow 10 is less likely to tip over as the bucket 30 is lower to the ground, reducing the ratio of the bucket height to wheelbarrow width and increasing the stability of the wheelbarrow. Moreover, the top of the bucket 30 is relatively low compared to the bucket size. This reduces the amount that a person must lift each shovel of dirt and reduces the workload of the person using the wheelbarrow 10.

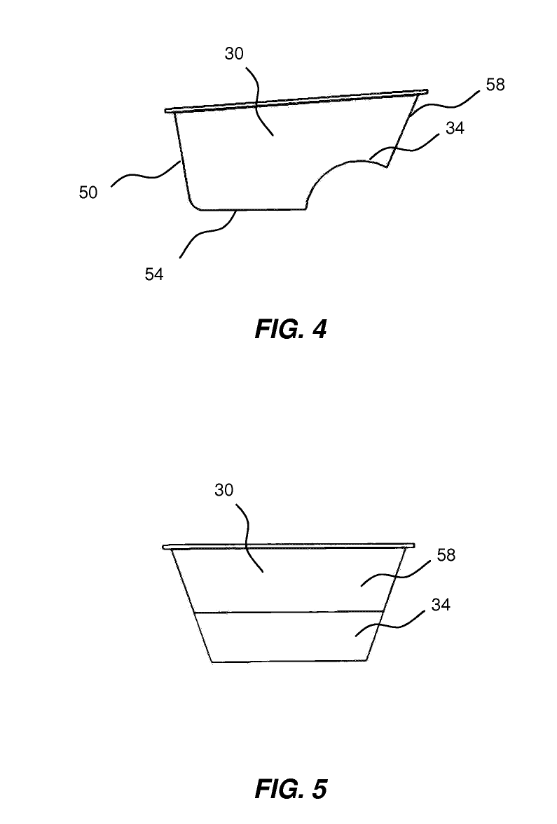

Turning now to FIGS. 4 and 5, side and front views of the wheelbarrow bucket 30 are shown. The bucket 30 may be formed from metal such as steel or other materials such as molded plastic. The bucket 30 may include a rear surface 50, a bottom surface 54, a front surface 58, a surface defining the recess 34, and side surfaces so that a closed bucket with an open top is formed. The recess 34 may extend across the width of the bucket 30. As such, the recess 34 may receive either one, two, or three wheels 14 disposed at varying locations across the front of the frame 18. The recess 34 may located at the lower front portion of the bucket 30 such that the recess eliminates the portion of the bucket where the lower surface 54 would meet the front surface 58 at a lower front corner. The recess 34 extends upwardly from the bottom surface 54 and backwards from the front surface 58 and forms a concavity where a lower front corner would otherwise be formed in the bucket 30; providing a concave recess to receive the wheels 14. According to one example, the recess 34 may be formed by a generally cylindrical surface which is arcuate in a front to back direction and which is generally straight in a side to side direction.

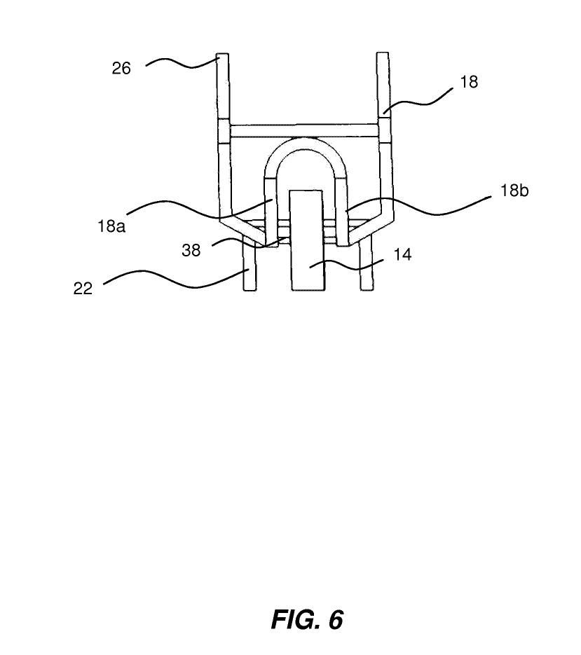

Turning now to FIG. 6, a front view of the frame 18 of the wheelbarrow 10 is shown. It can be seen how the frame sides 18a, 18b are typically closer together near the wheel 14 and farther apart near the handles 26. The frame 18 may have a steel plate, cross bars, or other structures which span between the frame sides 18a, 18b and support the bucket 30 or strengthen the frame 18.

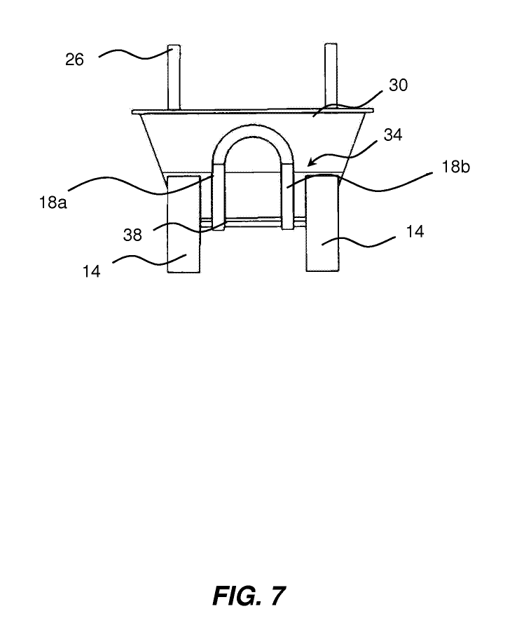

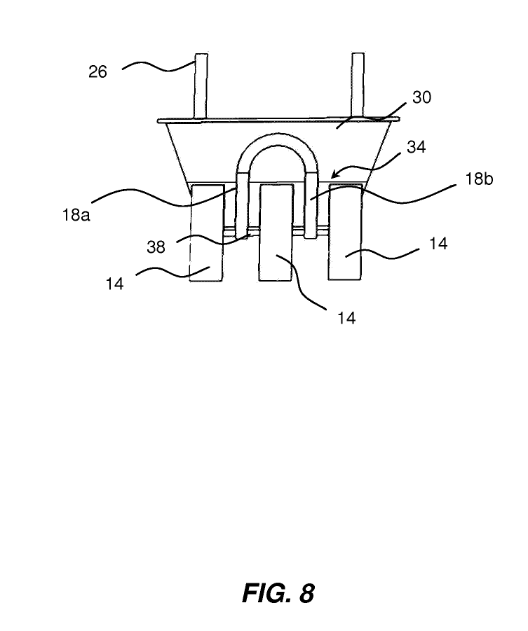

As illustrated in FIGS. 6 through 8, the wheelbarrow 10 may be provided with varying number of wheels 14. If desired, the wheelbarrow 10 may be provided with one, two, or three wheels. The number of wheels 14 may be changed with only a different size axle. A single short axle 38 may be used with a single wheel 14 and a longer axle 38 may be used with two or three wheels. The frame is relatively narrow at the front of the wheelbarrow 10, and allows a wheel 14 to fit between the sides 18a, 18b of the frame 18 at the front of the wheelbarrow 10. Side wheels 14, if used, may be attached on the outside of the frame sides 18a, 18b. Thus, two wheels 14 may be placed outside of the frame sides 18a, 18b while keeping these wheels 14 in the recess 34 and beneath the bucket 30 rather than placing these wheels to the sides of the bucket. Side wheels may be used in place of or in combination with a center wheel 14 to provide two or three wheels on the wheelbarrow.

If desired, the wheelbarrow 10 may be provided with both a long and a short axle and with three wheels, allowing a user to change the configuration of the wheelbarrow 10 as well as providing replacement wheels if a wheel is damaged. Some terrain such as sand, grass, dirt, etc. is sensitive to the amount of pressure placed on it and using more wheels 14 may allow the wheelbarrow to travel more easily across the terrain or may limit the damage to the terrain. Some terrain such as bumpy or uneven terrain may be easier to navigate with a wheelbarrow having fewer wheels.

The recess 34 in the bucket 30 allows one, two, or three wheels 14 to be positioned beneath the bucket on a common axle and allows the outside wheels 14 to be maintained near to the frame and underneath the bucket 30. Outside wheels 14 may extend upwardly into the recess 34 and have an axle 38 which is mounted in the plane of the lower surface of the bucket 30 and in the plane of the front surface of the bucket. This reduces the overall width of the wheelbarrow and reduces the width of the axle 38 used with two or three wheels. Wheelbarrows which place two wheels on the outside of the bucket require longer axles and place higher bending stress on the axles, making them less suitable for heavy materials. Additionally, these wheelbarrows are wider and can be more difficult to maneuver. The wheelbarrow 10 allows multiple wheels to be located beneath the bucket. Moreover, the bucket recess 34 allows the wheels 14 to be located upward into the bucket area, reducing the height of the bucket above the wheels.

The wheelbarrow 10 provides many advantages. A user does not need to lift objects very high in order to place these into the bucket 30 for the available capacity of the bucket, reducing the work necessary to fill the wheel barrow. This also reduces the strain on the user's back. There is reduced risk that the wheelbarrow 10 will tip over during filling as the bucket is maintained low to the ground. When a user is lifting the handles 26 to move the loaded wheelbarrow 10, the center of gravity 42 remains low. This improves the stability of the wheelbarrow 10 and, if the wheelbarrow 10 becomes slightly off-level while transporting a load, a user may easily level the wheelbarrow without spilling the load.

The frame 18 and the position of the wheels 14 relative to the bucket 30 give the user an increased mechanical advantage in lifting and maneuvering a loaded wheelbarrow, allowing them to lift and control a heavier load more easily. The position of the wheels 14 in the recess 34 provide a user with improved leverage in dumping the contents of the wheelbarrow 10, further improving the wheelbarrow handling. The wheelbarrow 10 provides additional stability and maneuverability than prior art wheelbarrows in nearly all modes of operation.

In one example, a wheelbarrow is provided. The wheelbarrow may include a frame which may include rear handles to allow a person to move the wheelbarrow, a bucket attached to the frame, and a wheel attached to the front of the frame, the wheel being attached to the frame such that the wheel is disposed beneath the bucket, a top of the wheel is disposed above a plane defined by a bottom surface of the bucket, and a back of the wheel is disposed behind a plane defined by a front surface of the bucket.

The wheelbarrow may include one or more of the above features and may also include a bucket which comprises a generally flat bottom surface and a generally linear front surface viewed from the side.

The wheelbarrow may include one or more of the above features and may also include an axle supporting the wheel, and may have an axis of the axle disposed in alignment with the bottom surface and with the front surface.

The wheelbarrow may include one or more of the above features and may also include a bucket which further includes a recess formed at a lower front portion of the bucket, and wherein the wheel is received into the recess.

The wheelbarrow may include one or more of the above features and may also include a recess which is generally concave.

The wheelbarrow may include one or more of the above features and may also include a frame which extends generally horizontally along the bottom surface and upwardly along the front surface.

The wheelbarrow may include one or more of the above features and may also include a frame which does not extend along the surface of the recess.

The wheelbarrow may include one or more of the above features and may also include a frame, a handle at the rear of the frame for allowing a user to lift the frame and move the wheelbarrow, a bucket for carrying a load, the bucket comprising a lower surface, a front surface, and a concave recess disposed between the lower surface and the front surface and extending upwardly into the bucket, and a wheel disposed in the recess such that a top of the wheel is located above the bottom surface of the bucket and a back of the wheel is located behind the front surface of the bucket.

The wheelbarrow may include one or more of the above features and may also include a recess defining a generally cylindrical surface.

The wheelbarrow may include one or more of the above features and may also include a wheel which is mounted to an axle disposed in alignment with the bottom surface of the bucket and in alignment with the top surface of the bucket.

The wheelbarrow may include one or more of the above features and may also include multiple wheels disposed on a common axle and located in the recess.

The above description of illustrated examples of the present invention, including what is described in the Abstract, are not intended to be exhaustive or to be limitation to the precise forms disclosed. While specific examples of the invention are described herein for illustrative purposes, various equivalent modifications are possible without departing from the broader scope of the present claims. Indeed, it is appreciated that specific example dimensions, materials, voltages, currents, frequencies, power range values, times, etc., are provided for explanation purposes and that other values may also be employed in other examples in accordance with the teachings of the present invention.

What is claimed is:

1. A wheelbarrow comprising:
a frame including a rear handle to allow a person to move the wheelbarrow;
a bucket attached to the frame; and
a wheel attached to a front of the frame, the wheel being attached to the frame such that the wheel is disposed beneath the bucket, a top of the wheel is disposed above a plane defined by a bottom surface of the bucket, and a back of the wheel is disposed behind a plane defined by a front surface of the bucket.

2. The wheelbarrow of claim 1, wherein the bucket comprises a generally flat bottom surface and a generally linear front surface viewed from the side.

3. The wheelbarrow of claim 2, further comprising an axle supporting the wheel, and wherein an axis of the axle is disposed adjacent a plane defined by the bottom surface of the bucket and adjacent a line defined by the front surface of the bucket.

4. The wheelbarrow of claim 2, wherein the bucket further comprises a recess formed at a lower front portion of the bucket, and wherein the wheel is received into the recess.

5. The wheelbarrow of claim 4, wherein the recess is generally concave.

6. The wheelbarrow of claim 4, wherein the recess extends upwardly from the bottom surface of the bucket and backwards from the front surface of the bucket.

7. The wheelbarrow of claim 4, wherein the frame extends generally horizontally along the bottom surface and upwardly along the front surface of the bucket.

8. The wheelbarrow of claim 7, wherein the frame does not extend along the surface of the recess.

9. The wheelbarrow of claim 1, wherein the wheelbarrow comprises two wheels which are disposed on a common axis and which are disposed beneath the bucket laterally.

10. A wheelbarrow comprising:
a frame;
a handle at the rear of the frame for allowing a user to lift the frame and move the wheelbarrow;
a bucket for carrying a load, the bucket comprising a lower surface, a front surface, and a concave recess disposed between the lower surface and the front surface and extending upwardly into the bucket; and
a wheel disposed in the recess such that a top of the wheel is located above the bottom surface of the bucket and a back of the wheel is located behind the front surface of the bucket.

11. The wheelbarrow of claim 10, wherein at least a portion of the recess defines a generally cylindrical surface.

12. The wheelbarrow of claim 10, wherein the wheel is mounted to an axle disposed in alignment with the bottom surface of the bucket and in alignment with the front surface of the bucket.

13. The wheelbarrow of claim 10, wherein the recess is defined by a surface which extends upwardly form the lower surface of the bucket and backwards from the front surface of the wheelbarrow.

14. The wheelbarrow of claim 10, wherein the recess extends laterally across a width of the bucket.

15. The wheelbarrow of claim 10, wherein the wheel is disposed on an axle which is located adjacent a plane defined by the lower surface of the bucket and adjacent a line defined by the front surface of the bucket.

16. The wheelbarrow of claim 10, wherein the wheelbarrow comprises multiple wheels disposed on a common axle and located in the recess.

17. The wheelbarrow of claim 16, wherein the multiple wheels are located laterally beneath the bucket.
